(19) United States
(12) Patent Application Publication
(10) Pub. No.: US 2015/0152291 A1
(43) Pub. Date: Jun. 4, 2015

(54) HYDROPHOBIC VINYL ESTER COPOLYMER DISPERSIONS

(71) Applicant: Celanese Emulsions GmbH, Sulzbach (Taunus) (DE)

(72) Inventors: Joerg Ludwig Schulte, Frankfurt (DE); Alistair Mclennan, Koenigstein (DE); Martin Jakob, Kelkheim (DE); Jeffrey Coulson, Cincinnati, OH (US); Trey Svrcek, Friendswood, TX (US)

(21) Appl. No.: 14/402,827

(22) PCT Filed: Jun. 18, 2013
(86) PCT No.: PCT/US2013/046276

§ 371 Date: Nov. 21, 2014

Related U.S. Application Data
(60) Provisional application No. 61/663,229, filed on Jun. 22, 2012.

(51) Int. Cl. C09J 4/00; C09J 11/08

(52) U.S. Cl. CPC C09J 4/00; C09J 11/08

(57) ABSTRACT

An aqueous copolymer dispersion is obtained by emulsion polymerization of a monomer mixture comprising, as main monomers, 10 to 35 weight % of ethylene, 30 to 60 weight % of a vinyl ester of a carboxylic acid having 1 to 9 carbon atoms and 15 to 50 weight % of a vinyl ester of a branched carboxylic acid having 3 to 15 carbon atoms. The monomer mixture also contains 0.1 to 10 weight % of an ethylenically unsaturated monocarboxylic or dicarboxylic acid having 3 to 4 carbon atoms and 0.1 to 10 weight % of a methacrylic or acrylic acid ester modified with epoxide groups and/or hydroxyl groups. The dispersion is stabilized with 0.02 to 2 weight % of a protective colloid, 0.01 to 5 weight % of a non-ionic surfactant and 0.01 to 5 weight % of an anionic surfactant. All weight percentages are based on the total weight of the main monomers.

### FIELD

The present application relates to hydrophobic vinyl ester copolymer dispersions and to their use as binders particularly, but not exclusively, in flooring adhesive formulations.

### BACKGROUND

Current practice in the flooring adhesives market is to employ binders based on acrylic and butadiene styrene emulsion polymers. There is, however, a need for a cost effective binder system that can provide improved value over existing acrylic and styrene butadiene emulsion polymers. An improved binder would desirably enable a formulator to use less tackifier and more filler content in an adhesive formulation, while delivering superior performance over competing products. Important performance properties include, for example, alkali resistance, water resistance, concrete and wood bond strength, shear strength, and rebond strength. Also, in view of increasingly stringent environmental regulations, it is important to provide a binder system that exhibits low emission of volatile organic compounds, such as formaldehyde.

U.S. Pat. No. 6,746,555 discloses a low-emission adhesive, suitable for use as a flooring, wall or ceiling adhesive, based on an aqueous, vinyl acetate-ethylene copolymer dispersion obtainable by free-radically initiated emulsion polymerization of a comonomer mixture comprising (a) from 5 to 50% by weight of ethylene, (b) from 20 to 80% by weight of at least one vinyl ester from the group of vinyl esters of unbranched or branched carboxylic acids having 1 to 9 carbon atoms whose homopolymers have a glass transition temperature T_{g}>0° C., (c) from 5 to 70% by weight of at least one vinyl ester from the group of vinyl esters of branched carboxylic acids having 8 to 13 carbon atoms whose homopolymers have a glass transition temperature T_{g}<0° C., (d) from 0.5 to 10% by weight of at least one ethylenically unsaturated monocarboxylic or dicarboxylic acid having 3 or 4 carbon atoms, (e) from 0 to 10% by weight of at least one ethylenically unsaturated, hydroxyalkyl-functional comonomer, and (f) from 0 to 10% by weight of further, mono- or polyethylenically unsaturated comonomers. The dispersion is stabilized by one or more emulsifiers present in an amount from 0.1 to 5% by weight of the overall weight of comonomers but with the exclusion of protective colloids.

U.S. Pat. No. 5,665,816 discloses that aqueous dispersions prepared by polymerization of vinyl acetate, ethylene, and comonomers selected from the group consisting of vinyl esters of aliphatic (C₃-C₁₈)-carboxylic acids, acrylic acid esters, methacrylic acid esters, and maleic acid diesters of aliphatic (C₁-C₁₈)-alcohols in the presence of 0.05 to 0.95% by weight of α,B-unsaturated carboxylic acids, 0 to 0.95% by weight of methacrylic acid esters or acrylic acid esters which carry epoxide or hydroxyl groups, and 1.5 to 20% by weight of cellulose ether, to form a copolymer having a glass transition temperature of −40° C. to 0° C. and comprising a cellulose ether in at least partly grafted form, are suitable as adhesives, for example, for gluing polyolefins.

EP 0 295 727 A2 discloses that latices prepared by emulsion polymerisation comprise an interpolymer of (a) vinyl acetate, (b) ethylene and (c) the vinyl ester of a tertiary aliphatic carboxylic acid in which the acid moiety contains 9 carbon atoms are suitable for use in emulsion paints.

U.S. Pat. No. 6,616,798 discloses process for preparing an adhesive useful in paper, packaging, wood and textiles and in structural adhesives and having a Tg in the range of about −30° C. to 40° C. The adhesive is prepared by emulsion polymerization of a comonomer mixture comprising a) predominant monomers consisting essentially of from 30 to 95 weight percent vinyl acetate monomer and optionally from 60 to 1 weight percent ethylene monomer, said weight percents based on the total weight of all monomers and b) from about 2.5 to about 20.5% by weight, based on the overall weight of the comonomer mixture, of vinyl esters of alpha-branched tertiary monocarboxylic acids of 11 carbon atoms, in the presence of c) from 0.1 to 15% by weight, based on the overall weight of monomers, a) and b) of polyvinyl alcohol.

According to the present invention, it has now been found that certain aqueous copolymer dispersions, which are based on vinyl ester, ethylene and a hydrophobic comonomer and which are stabilized with a combination of non-ionic and anionic surfactants together with a protective colloid, exhibit excellent adhesive properties as well as the improved alkali resistance and water resistance required for use as a flooring adhesive. The present dispersions are also suited for other applications, for example in caulks, sealants and for paints and coatings.

### SUMMARY

In one aspect, the invention resides in an aqueous copolymer dispersion obtainable by free-radically initiated emulsion polymerization of an aqueous composition comprising:

(A) a monomer mixture comprising:
(i) 10 to 35 weight %, such as 15 to 30 weight %, of ethylene;
(ii) 30 to 60 weight %, such as 40 to 55 weight %, of a vinyl ester of a carboxylic acid having 1 to 9 carbon atoms, whose homopolymer has a glass transition temperature, Tg, greater than 0° C.;
(iii) 15 to 50 weight %, such as 20 to 40 weight %, of a vinyl ester of a branched carboxylic acid having 5 to 15 carbon atoms, whose homopolymer has a glass transition temperature, Tg, less than 0° C.;
(iv) 0.1 to 10 weight %, such as 0.5 to 2 weight %, of an ethylenically unsaturated monocarboxylic or dicarboxylic acid having 3 to 4 carbon atoms; and
(v) 0.1 to 10 weight %, such as 0.5 to 2 weight %, of a methacrylic or acrylic acid ester modified with one or more groups selected from epoxide groups and hydroxyl groups,

wherein the weight percentages of the monomers in the monomer mixture are based on the total weight of the monomers (i), (ii) and (iii); and

(B) a stabilizer system comprising:
(a) 0.02 to 2 weight % of a protective colloid;
(b) 0.01 to 5 weight % of a non-ionic surfactant; and
(c) 0.01 to 5 weight % of an anionic surfactant

wherein the weight percentages of the components of the stabilizer system are based on the total weight of the monomers (i), (ii) and (iii).

Typically, the vinyl ester (ii) comprises vinyl acetate and the vinyl ester (iii) comprises a vinyl ester of a branched carboxylic acid having 8 to 13 carbon atoms, especially a vinyl ester having the following formula:

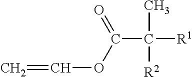

wherein R¹ and R² are alkyl groups containing a total of 7 or 8 carbon atoms.

Generally, the ethylenically unsaturated monocarboxylic or dicarboxylic acid (iv) comprises acrylic acid and the modified methacrylic or acrylic acid ester (v) comprises glycidyl methacrylate.

In one embodiment, the monomer mixture also comprises 0.01 to 5 weight %, preferably 0.2 to 1.5 weight %, based on the total weight of the monomers (i), (ii) and (iii), of an ethylenically unsaturated sulfonic acid, preferably vinyl sulfonic acid, or salt thereof.

In a further aspect, the invention resides use of the present aqueous copolymer dispersion in an adhesive formulation, particularly for use as a flooring adhesive.

### DETAILED DESCRIPTION

The aqueous copolymer dispersion described herein is formed by emulsion polymerization of a monomer mixture comprising, as main monomers, (i) ethylene, (ii) a vinyl ester whose homopolymer has a glass transition temperature, Tg, greater than 0° C. and (iii) a vinyl ester of a branched carboxylic acid whose homopolymer has a glass transition temperature, Tg, less than 0° C. The copolymer dispersion is stabilized with a combination of non-ionic and anionic surfactants together with a protective colloid and, when used in an adhesive formulation is found to provide superior adhesive properties as well as improved alkali resistance and water resistance. The glass transition temperatures referred to herein are calculated by the Fox Flory equation.

The ethylene content of the monomer mixture is generally 10 to 35 weight %, such as 15 to 30 weight %, typically 20 to 25 weight %, based on the total weight of the main monomers (i), (ii) and (iii).

The main monomer (ii) in the monomer mixture comprises at least one vinyl ester of a branched or unbranched carboxylic acid which has 1 to 9 carbon atoms and whose homopolymer has a glass transition temperature, Tg, greater than 0° C. Examples of such monomers (ii) include vinyl acetate, vinyl propionate, vinyl butyrate, 1-methylvinyl acetate, vinyl pivalate, and vinyl esters of α-branched monocarboxylic acids having 9 carbon atoms, such as VeoVa9®. Particularly preferred is vinyl acetate. Generally, the main monomer (ii) is present in the monomer mixture in an amount from 30 to 60 weight %, such as 40 to 55 weight %, typically 45 to 50 weight % based on the total weight of the main monomers (i), (ii) and (iii).

The main monomer (iii) in the monomer mixture comprises at least one vinyl ester of a branched carboxylic acid which has 5 to 15 carbon atoms, generally 8 to 13 carbon atoms, and whose homopolymer has a glass transition temperature, Tg, less than 0° C. Examples of such monomers (iii) include vinyl 2-ethylhexanoate, vinyl esters of α-branched monocarboxylic acids having 10 or 11 carbon atoms, and vinyl esters of branched monocarboxylic acids having 10 to 13 carbon atoms, such as Exxar Neo12. Preferred monomers (iii) include vinyl esters having the formula:

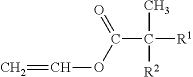

wherein R¹ and R² are alkyl groups containing a total of 7 or 8 carbon atoms. Such materials are commercially available under the trade names VeoVa10® and VeoVa11®. Generally, the main monomer (iii) is present in the monomer mixture in an amount from 15 to 50 weight %, such as 20 to 40 weight %, typically 25 to 35 weight % based on the total weight of the main monomers (i), (ii) and (iii).

In addition to the main monomers, the monomer mixture used to produce the present dispersion comprises 0.1 to 10 weight %, such as 0.5 to 2 weight %, typically 0.5 to 1.5 weight % [based on the total weight of the main monomers (i), (ii) and (iii)] of each of two further comonomers (iv) and (v).

The comonomer (iv) comprises at least one ethylenically unsaturated monocarboxylic or dicarboxylic acid having 3 to 4 carbon atoms. Examples of suitable comonomers (iv) comprise acrylic acid, methacrylic acid, itaconic acid, fumaric acid, and maleic acid, with acrylic and methacrylic acids being preferred.

The comonomer (v) comprises at least one methacrylic or acrylic acid ester modified with one or more groups selected from epoxide groups and hydroxyl groups. Examples of suitable epoxy modified esters include glycidyl methacrylate and glycidyl acrylate. Examples of suitable hydroxyl modified esters include hydroxyalkyl esters having a C₁ to C₅ alkyl radical such as hydroxyethyl, hydroxypropyl or hydroxybutyl acrylate or methacrylate. The preferred comonomer (v) is glycidyl methacrylate.

Optionally, the monomer mixture also includes up to 10 weight %, such as from 0.01 to 5 weight %, preferably 0.2 to 1.5 weight %, again based on the total weight of the monomers (i), (ii) and (iii), of one or more further mono- or poly-ethylenically unsaturated comonomers (vi). Examples of suitable comonomers (vi) include functional comonomers, such as ethylenically unsaturated carboxamides and carbonitriles, for example acrylamide and acrylonitrile; monoesters and diesters of fumaric acid and maleic acid, such as the diethyl and diisopropyl esters and also maleic anhydride; ethylenically unsaturated sulfonic acids and their salts, preferably vinylsulfonic acid, 2-acrylamido-2-methylpropanesulfonic acid. Further examples are pre-crosslinking comonomers, such as polyethylenically unsaturated comonomers, for example divinyl adipate, diallyl maleate, allyl methacrylate and triallyl cyanurate and post-crosslinking comonomers, such as N-methylolacrylamide (NMA), N-methylolmethacrylamide, alkyl esters such as the isobutyoxy ether or esters of N-methylolacrylamide. Also suitable are are silicon-functional comonomers, such as acryloxypropyltri(alkoxy)- and methacryloxypropyltri(alkoxy)-silanes, vinyltrialkoxysilanes, and vinylmethyldialkoxysilanes.

Generally, the monomers (i) and (vi) are present in the monomer mixture so that the copolymer produced on emulsion polymerization of the monomer mixture has a Tg of about −30° C. to about 0° C.

Emulsion polymerization of the monomer mixture described above can be conducted by any known procedure which results in the production of a copolymer dispersion in aqueous latex form. Suitable procedures are described, for example, in U.S. Pat. No. 5,633,334, and in the Encyclopedia of Polymer Science and Engineering, Vol. 8, p. 659 ff (1987). The disclosures of both of these publications are incorporated herein by reference in their entirety.

The polymerization may be carried out in one, two or more stages with different monomer combinations, giving polymer dispersions having particles with homogeneous or heterogeneous, e.g., core shell or hemispheres, morphology. Any reactor system such as batch, loop, continuous, cascade, etc, may be employed.

The polymerization temperature generally ranges from about 20° C. to about 150° C., more preferably from about 50° C. to about 120° C. The polymerization generally takes place under pressure if appropriate, preferably from about 2 to about 150 bar, more preferably from about 5 to about 100 bar.

In a typical polymerization procedure involving, for example, vinyl acetate/ethylene copolymer dispersions, the vinyl acetate, ethylene, stabilizing system and other co-monomers can be polymerized in an aqueous medium under pressures up to about 120 bar in the presence of one or more initiators. The aqueous reaction mixture in the polymerization vessel can be maintained by a suitable buffering agent at a pH of about 2 to about 7.

The manner of combining the several polymerization ingredients, i.e., stabilizing system, co-monomers, catalyst system components, etc., can vary widely. Generally an aqueous medium containing at least part of the stabilizing system can be initially formed in a polymerization vessel with the various other polymerization ingredients being added to the vessel thereafter.

Co-monomers can be added to the polymerization vessel continuously, incrementally or as a single charge addition of the entire amounts of co-monomers to be used. Co-monomers can be employed as pure monomers or can be used in the form of a pre-mixed emulsion. Ethylene as a co-monomer can be pumped into the polymerization vessel and maintained under appropriate pressure therein.

As noted above, the polymerization of the comonomer mixture will generally take place in the presence of at least catalyst for the free-radical polymerization of these co-monomers. Suitable polymerization catalysts include the water-soluble free-radical-formers (initiators) generally used in emulsion polymerization, such as hydrogen peroxide, sodium persulfate, potassium persulfate and ammonium persulfate, as well as tert-butyl hydroperoxide, in amounts of between 0.01% and 3% by weight, preferably 0.01% and 1% by weight, based on the total amount of the emulsion. These materials can be used together with reducing agents, such as sodium formaldehyde-sulfoxylate, ferrous salts, sodium dithionite, sodium hydrogen sulfite, sodium sulfite, sodium thiosulfate, the sodium salt of hydroxymethanesulfinic acid, Brüggolit FF6 and FF7 as redox catalysts in amounts of 0.01% to 3% by weight, preferably 0.01% to 1% by weight, based on the total amount of the emulsion. The free-radical-formers can be added to the aqueous emulsifier solution initially present in the polymerization vessel or can be added during the polymerization in staged doses. When redox systems are to be formed in the polymerization vessels, the initiator should be added separately, e.g., in separate solutions, from the reducing agent(s).

Both during polymerization and thereafter, the present copolymer dispersion is stabilized in the form of an aqueous copolymer dispersion or latex by means of a stabilization system comprising a protective colloid and a combination of both non-ionic and anionic surfactants. Generally the protective colloid is present in an amount from 0.02 to 2 weight %, such as from 0.05 to 1 weight %, whereas the non-ionic surfactant is present in an amount from 0.01 to 5 weight %, such as from 0.05 to 1 weight % and the anionic surfactant is present in an amount from 0.01 to 5 weight %, such as from 0.05 to 1 weight %, wherein all weight % are based on the total weight of the monomers (i), (ii) and (iii). The weight ratio of the non-ionic to anionic surfactants may fluctuate within wide ranges, such as between 1:1 and 50:1, generally between 1:1 and 16:1.

Examples of suitable nonionic emulsifiers include acyl, alkyl, oleyl, and alkylaryl ethoxylates. These products are commercially available, for example, under the name Genapol®, Lutensol®, Emulsogen® EPN 287 or Emulan®. They include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₂-C₁₄ fatty alcohol (3-40) ethoxylates, C₁₃-C₁₅ oxo-process alcohol (3-40) ethoxylates, C₁₆-C₁₈ fatty alcohol (11-80) ethoxylates, C₁₀ oxo-process alcohol (3-40) ethoxylates, C₁₃ oxo-process alcohol (3-40) ethoxylates, polyoxyethylenesorbitan monooleate with 20 ethylene oxide groups, copolymers of ethylene oxide and propylene oxide having a minimum ethylene oxide content of 10% by weight, the polyethylene oxide (4-40) ethers of oleyl alcohol, and the polyethene oxide (4-40) ethers of nonylphenol. Particularly suitable are the polyethylene oxide (4-40) ethers of fatty alcohols, more particularly of oleyl alcohol, stearyl alcohol or C₁₁ alkyl alcohols.

Examples of suitable anionic emulsifiers include sodium, potassium, and ammonium salts of linear and branched aliphatic carboxylic acids of chain length C₁₂-C₂₀, sodium hydroxyoctadecanesulfonate, sodium, potassium, and ammonium salts of hydroxy fatty acids of chain length C₁₂-C₂₀ and their sulfonation and/or sulfation and/or acetylation products, alkyl sulfates, including those in the form of triethanolamine salts, alkyl(C₁₀-C₂₀) sulfonates, alkyl(C₁₀-C₂₀) arylsulfonates, dimethyl-dialkyl (C₈-C₁₈) ammonium chloride, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, sodium lauryl sulfate, sulfated alkyl or aryl ethoxylate with EO degree between 1 and 10, for example ethoxylated sodium lauryl ether sulfate (EO degree 3) or a salt of a bisester, preferably of a bis-C₄-C₁₈ alkyl ester, of a sulfonated dicarboxylic acid having 4 to 8 carbon atoms, or a mixture of these salts, preferably sulfonated salts of esters of succinic acid, more preferably salts, such as alkali metal salts, of bis-C₄-C₁₈ alkyl esters of sulfonated succinic acid, or phosphates of polyethoxylated alkanols or alkylphenols.

Examples of suitable protective colloids include water-soluble or water-dispersible polymeric modified natural substances, such as cellulose ethers, examples being methyl, ethyl-, hydroxyethyl- or carboxymethylcellulose; water-soluble or water-dispersible polymeric synthetic substances, such as polyvinylpyrrolidone or polyvinyl alcohols or their copolymers (with or without residual acetyl content), and polyvinyl alcohol which is partially esterified or acetalized or etherified with saturated radicals, and also with different molecular weights. Preferably, the protective colloid is a cellulose ether, particularly hydroxyethylcellulose.

The copolymer dispersions as prepared herein will generally have a viscosity of at least 1000 mPas, such as about 1000 mPas to about 10000 mPas at 65% solids and 25° C., as measured with a Brookfield viscometer at 20 rpm, with appropriate spindle. Viscosity may be adjusted by the addition of thickeners and/or water to the copolymer dispersion. Suitable thickeners can include polyacrylates or polyurethanes, such as Borchigel L75® and Tafigel PUR 60®. Alternatively, the copolymer dispersion may be substantially free of thickeners.

Following polymerization, the solids content of the resulting aqueous copolymer dispersions can be adjusted to the level desired by the addition of water or by the removal of water by distillation. Generally, the desired level of polymeric solids content after polymerization is from about 60 weight percent to about 70 weight percent based on the total weight of the polymer dispersion, more preferably from about 64 weight percent to about 67 weight percent. Prior to use the present copolymer dispersion can be spray dried to produce a redispersible powder.

The copolymer dispersion described herein can be used in a variety of applications, such as in adhesives, caulks, sealants and for paints and coatings. The dispersion is, however, particularly intended for use in adhesive formulations, especially flooring adhesives. When formulated into an adhesive, the aqueous copolymer dispersions described herein may be combined with additives which are typical for use in the production of dispersion-based adhesives. Typical additives include fillers, such as alkaline earth metal oxides, alkaline earth metal carbonates and/or silicates and tackifier resins, such as rosin ester, styrenated terpene, terpene phenolics. A typical adhesive formulation may therefore contain from 15 to 70 weight % of the present copolymer dispersion, from 0 to 50 weight % of a filler and from 5 to 50 weight % of a tackifier resin.

Other suitable additives include, for example, film-forming assistants, such as white spirit, Texanol®, TxiB®, butyl glycol, butyldiglycol, butyldipropylene glycol, and butyltripropylene glycol, toluene; plasticizers, such as dimethyl phthalate, dibutyl phthalate, diisobutyl phthalate, diisobutyl adipate, Coasol B®, Plastilit 3060®, and Triazetin®; wetting agents, such as AMP 90®, TegoWet.280®, Fluowet PE®; thickeners, such as polyacrylates or polyurethanes, such as Borchigel L759®. and Tafigel PUR 60®; defoamers, such as mineral oil defoamers or silicone defoamers; UV protectants, such as Tinuvin 1130®, subsequently added stabilizing polymers, such as polyvinyl alcohol or cellulose ethers, and other additives and auxiliaries of the kind typical for the formulation of adhesives.

The fraction of these additives in the final dispersion-based adhesive can be up to 25% by weight, preferably 2% to 15% by weight, and in particular 5% to 10% by weight, based on the dispersion.

The invention will now be more particularly described with reference to the following non-limiting Examples.

### Example 1

A reactor comprising a 26.9 liter pressure vessel equipped with a stirrer was charged with the following:
5.9 kg water
29 g Hydroxyethylcellulose
750 g Alcohol ethoxylate (28 EO) non-ionic surfactant (70% solution in water)
230 g Sodium alkylpolyethylene glycol ether (7 EO) sulfate (28% solution in water)
127 g Sodium vinyl sulphonate (30% in water)
7 g Sodium formaldehyde sulfoxylate
0.04 g Mohr's salt.

The vessel was evacuated and flushed with nitrogen. Stirring was turned on and then the vessel was charged with:
7.4 kg Vinyl acetate
2.3 kg VeoVa 10.

A separate monomer slow addition vessel was charged with:
2.3 kg VeoVa 10
129 g Glycidyl methacrylate
129 g Acrylic acid.

The reactor was then charged with:
3.4 kg of Ethylene.

Two separate addition vessels were charged with solutions of:

### Vessel 1: Reducer

0.4 kg Water
29 g Sodium formaldehyde sulfoxylate

### Vessel 2: Oxidizer

0.4 kg water
72 g Sodium persulphate
20 g Sodium bicarbonate

Polymerization was carried out at 65° C. by adding to the reactor the reducer over a period of 300 minutes, the oxidizer over a period of 630 minutes and the monomer mixture (prepared in the monomer slow addition vessel) over a period of 280 minutes (starting together with addition of reducer and oxidizer start). 90 minutes after completion of the monomer addition, the batch was heated to 75° C. until the end of the oxidizer addition. After the additions were complete, the batch was cooled to 40° C. and the crude polymer product was discharged from the reactor.

To effect monomer removal from the crude polymer product, 9.2 kg of the product was transferred to a pressure-less 10 liter lab reactor together with 9.3 g defoamer (Agitan 301) and 55 g water. The mixture was heated to 65° C. while stirring. A solution of 14 g tert-butylhydroperoxide in 46 ml water was added dropwise and the mixture was stirred at 65° C. for 1 hour. Then a solution of 7.4 g sodium formaldehyde sulfoxylate in 67 ml of water was added over a period of 1 hour. After stirring for 4 hours at 65° C. the mixture was cooled to 40° C. and the pH was adjusted to 4 (+/−0.1) by addition of a 7% solution of sodium hydroxide in water. Then a solution of 31 g urea in 46 ml water was added as a formaldehyde scavenger.

The results of three separate polymerization runs are summarized in Table 1 below, in which the viscosity is measured at 25° C. with a Brookfield viscometer at 20 rpm, with spindle 4 and particle size, dw, is measured by Xe-Laser-Aerosol-Spectroscopy. For a description of Xe-Laser-Aerosol-Spectroscopy, Xe-LAS see: J. P. Fischer in,, FH Texte der Fachhochschule Aachen”, Bd. 66 (1995), as well as Kunstharz Nachrichten 28, 12 ff (1991) and EP 0826008 (A1)

TABLE 1

| | Solids | | Viscosity | HPLC | Vinyl | VeoVa | Particle | Tg |
|---|---|---|---|---|---|---|---|---|
| Run | Content | | (4/20) | Formaldehyde | acetate | 10 | size | mid |
| No. | [%] | pH | [cps] | [ppm] | [ppm] | [ppm] | (nm) | [° C.] |
| 1 | 64.7 | 4.8 | 2700 | n.d. | 2800.0 | 4700.0 | 200 | −15 |
| 2 | 65.6 | 3.7 | 1200 | 41.0 | 1252.0 | 835.0 | 164 | −15 |
| 3 | 65.1 | 3.2 | 1900 | 44.0 | 1303.0 | 1186.0 | 190 | −15 |

### Example 2

The tensile strength and elongation at break of a polymer film produced from the dispersion of Run 2 of Example 1 were measured according to ASTM D638 and D1456 respectively. The measurements were then repeated after immersion of separate samples of the film in (a) water, (b) 20 wt % sodium hydroxide and (c) dioctyl phthalate (DOP) plasticizer according to ASTM D896. The results are shown in Table 1 which also provides the results of comparative tests conducted on a polymer film produced from Acronal-378, a commercially available butyl acrylate/acronitrile polymer dispersion supplied by BASF.

It will be seen from Table 2 that the dispersion of Example 1 produced a polymer film with 100% higher water resistance, equivalent alkali resistance and marginally (7%) lower plasticizer resistance than the film produced with Acronal-378.

### Example 3

Flooring adhesive formulations were produced from the dispersion of Run 2 of Example 1 and, for comparison, from Acronal-378. In each case the formulation was produced according to the following recipe.

| | Parts by Mass (wet) |
|---|---|
| Polymer binder | 41.05 |
| Defoamer | 0.18 |
| Tamol 850 (Dispersant) | 0.34 |
| Triton X 405 (Surfactant) | 0.60 |
| Aquatack 6025 (Tackifier) | 31.83 |
| Omyacarb 12 (Calcium carbonate) | 25.04 |
| Acrysol TT-615 (Thickener) | 0.70 |
| Ethanolamine (pH adjustment) | 0.27 |
| TOTAL | 100.0 |

The results of testing the adhesive formulations are shown in Table 3, where the bond (stripping) strength tests were conducted according to ASTM D903, the shear strength tests were conducted according to ASTM D6004, the 90 degree peel strength tests were conducted according to ASTM D6862, the rebond/retack strength tests were conducted according to ASTM D7532 and the open assembly/working time tests were conducted according to ASTM D6325.

It will be seen from Table 3 that the adhesive formulation produced from the dispersion of Example 1 exhibited improved wood bond strength, rebond shear strength and water and alkali resistance than the adhesive formulation produced Acronal-378. Both formulations exhibited similar cement bond strength and carpet peel and shear strength.

TABLE 2

| | | Tensile Strength, | | Tensile Strength, | | Tensile Strength, | |
|---|---|---|---|---|---|---|---|
| | Tensile Strength, | psi (Elongation) | % Strength | psi (Elongation) | % Strength | psi (Elongation) | % Strength |
| Product | psi (Elongation) | 1 day in water | retained | 1 day in 20% NaOH | retained | 1 day in DOP | retained |
| Example 1 | 59 (>1390%) | 57 (>1390%) | 97% | 68 (>1390%) | 95% | 28 (>1390%) | 47% |
| Acronal 378 | 68 (>1390%) | 32 (>1390%) | 47% | 57 (>1390%) | 97% | 37 (>1390%) | 54% |

TABLE 3

| | Cement | Cement bond | Cement bond | Cement bond | Cement bond | Wood | 90° | | | Rebond |
|---|---|---|---|---|---|---|---|---|---|---|
| | bond | Strength, lbF | Strength, lbF | Strength, lbF | Strength, lbF | bond | carpet | Carpet | | shear |
| | Strength, | 1 day in | 6 days in | 1 day in | 6 days in | strength | peel | shear | Working | (4 hrs open |
| Product | Ibf | water | water | 20% NaOH | 20% NaOH | lbf | strength | strength | time | time) |
| Example 1 | 29.84 | 18.3 (61%) | 9.9 (33%) | 26.5 (89%) | 38.8 (130%) | 48.43 | 21.3 | >120 | 80 | 4.89 |
| Acronal 378 | 27.20 | 11.97 (44%) | 2.3 (8%) | 24.91 (92%) | 3.4 (13%) | 19.4 | 21.6 | >120 | 90 | 0.5 |

1. An aqueous copolymer dispersion obtainable by free-radically initiated emulsion polymerization of an aqueous composition comprising:
(A) a monomer mixture comprising:
(i) 10 to 35 weight % of ethylene;
(ii) 30 to 60 weight % of a vinyl ester of a carboxylic acid having 1 to 9 carbon atoms, whose homopolymer has a glass transition temperature, Tg, greater than 0° C.;
(iii) 15 to 50 weight % of a vinyl ester of a branched carboxylic acid having 3 to 15 carbon atoms, whose homopolymer has a glass transition temperature, Tg, less than 0° C.;
(iv) 0.1 to 10 weight % of an ethylenically unsaturated monocarboxylic or dicarboxylic acid having 3 to 4 carbon atoms; and
(v) 0.1 to 10 weight % of a methacrylic or acrylic acid ester modified with one or more groups selected from epoxide groups and hydroxyl groups,
wherein the weight percentages of the monomers in the monomer mixture are based on the total weight of the monomers (i), (ii) and (iii); and
(B) a stabilizer system comprising:
(a) 0.02 to 2 weight % of a protective colloid;
(b) 0.01 to 5 weight % of a non-ionic surfactant; and
(c) 0.01 to 5 weight % of an anionic surfactant
wherein the weight percentages of the components of the stabilizer system are based on the total weight of the monomers (i), (ii) and (iii).

2. The copolymer dispersion of claim 1, wherein the monomer mixture comprises 15 to 30 weight % of ethylene.

3. The copolymer dispersion of claim 1, wherein the monomer mixture comprises 40 to 55 weight % of the vinyl ester (ii).

4. The copolymer dispersion of claim 1, wherein the monomer mixture comprises 20 to 40 weight % of the vinyl ester (iii).

5. The copolymer dispersion of claim 1, wherein the monomer mixture comprises 0.5 to 2 weight % of the ethylenically unsaturated monocarboxylic or dicarboxylic acid (iv).

6. The copolymer dispersion of claim 1, wherein the monomer mixture comprises 0.5 to 2 weight % of the methacrylic or acrylic acid ester (v).

7. The copolymer dispersion of any claim 1, wherein the vinyl ester (ii) comprises vinyl acetate.

8. The copolymer dispersion of claim 1, wherein the vinyl ester (iii) comprises a vinyl ester of a branched carboxylic acid having 8 to 13 carbon atoms.

9. The copolymer dispersion of claim 8, wherein the vinyl ester of a branched carboxylic acid having 3 to 15 carbon atoms comprises the following structure: 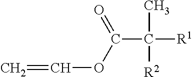
wherein R¹ and R² are alkyl groups containing a total of 7 or 8 carbon atoms.

10. The copolymer dispersion of claim 1, wherein the ethylenically unsaturated monocarboxylic or dicarboxylic acid (iv) comprises acrylic acid.

11. The copolymer dispersion of claim 1, wherein the modified methacrylic or acrylic acid ester (v) comprises glycidyl methacrylate.

12. The copolymer dispersion of claim 1, wherein the monomer mixture also comprises 0.01 to 5 weight %, preferably 0.2 to 1.5 weight %, based on the total weight of the monomers (i), (ii) and (iii), of an ethylenically unsaturated sulfonic acid, preferably vinyl sulfonic acid, or salt thereof.

13. The copolymer dispersion of claim 1, wherein the protective colloid comprises hydroxyethylcellulose.

14. The copolymer dispersion of claim 1 and having a solids content of at least 60 weight %.

15. A redispersible powder produced by drying the copolymer dispersion of claim 1.

16. An adhesive formulation comprising the copolymer dispersion of claim 1.

17. An adhesive formulation comprising the redispersible powder of claim 15.
